(19) United States
(12) Patent Application Publication
(10) Pub. No.: US 2012/0310470 A1
(43) Pub. Date: Dec. 6, 2012

(54) WHEELCHAIR SYSTEM HAVING A SHORT RANGE WIRELESS INTERFACE TO AN INTERMEDIARY DEVICE FOR RELAYING DIAGNOSTIC-RELATED AND OPERATIONAL PROGRAM INFORMATION TO AND FROM A REMOTE SITE

(75) Inventors: Matthias Holenweg, Buren an der Aare (CH); Michael Rozaieski, Springfield, KY (US)

(73) Assignee: Curtis Instruments, Inc.

(21) Appl. No.: 13/454,416

(22) Filed: Apr. 24, 2012

Related U.S. Application Data
(60) Provisional application No. 61/491,611, filed on May 31, 2011.

(51) Int. Cl. G06F 7/00

(52) U.S. Cl. 701/31.5

(57) ABSTRACT

A personal mobility vehicle, such as a wheelchair system, includes a short range wireless interface and a control unit having a data processor and a memory. The data processor is coupled to the wireless interface and is configured to wirelessly transmit vehicle diagnostic-related data from the memory to an intermediary device via the short range wireless interface for subsequent transmission from the intermediary device to a remote site. The data processor is further configured to wirelessly receive via the short range wireless interface with the intermediary device at least operational program related data from the remote site.

### CLAIM OF PRIORITY FROM COPENDING PROVISIONAL PATENT APPLICATION

This patent application claims priority under 35 U.S.C. §119(e) from Provisional Patent Application No. 61/491,611, filed May 31, 2011, the disclosure of which is incorporated by reference herein in its entirety.

### TECHNICAL FIELD

The exemplary embodiments of this invention relate generally to personal mobility vehicles such as wheelchairs, and more specifically relate to diagnostic and control software systems and user interfaces for such vehicles.

### BACKGROUND

Self-powered personal mobility vehicles, such as wheelchairs having a self-contained power source to provide drive power to wheels and steering actuators, may include a data processor subsystem to control the various power and motive subsystems of the vehicle, as well as to implement a user interface function enabling an occupant of the vehicle to control the overall operation of the vehicle, such as to start, stop and steer the vehicle.

A problem that can be presented relates to providing a simple, robust and low cost interface to enable personal mobility vehicle maintenance and diagnostic-related information to be monitored and reviewed by a technical person at a remote location, who then may wish to install new/revised control software on the personal mobility vehicle.

### SUMMARY

The foregoing and other problems are overcome, and other advantages are realized, in accordance with the presently preferred embodiments of this invention.

The exemplary embodiments of this invention provide a personal mobility vehicle, such as a wheelchair system, that comprises a short range wireless interface and a control unit that comprises a data processor and a memory. The data processor is coupled to the wireless interface and is configured to wirelessly transmit vehicle diagnostic-related data from the memory to an intermediary device via the short range wireless interface for subsequent transmission from the intermediary device to a remote site. The data processor is further configured to wirelessly receive via the short range wireless interface with the intermediary device at least operational program related data from the remote site.

For example, a further aspect of the exemplary embodiments of this invention is a method that comprises wirelessly transmitting vehicle diagnostic-related data from the personal mobility vehicle to an intermediary device via a short range wireless connection; further transmitting the vehicle diagnostic-related data from the intermediary device to a remote site; and wirelessly receiving via the short range wireless connection with the intermediary device at least operational program related data from the remote site.

Further by example, another non-limiting aspect of the exemplary embodiments of this invention is a non-transitory computer-readable medium that tangibly stores a computer program for execution by a data processor to operate a wheelchair system by performing operations that comprise wirelessly transmitting vehicle diagnostic-related data from the wheelchair system to an intermediary device via a short range wireless connection so that the vehicle diagnostic-related data can be relayed to a remote site; and wirelessly receiving via the short range wireless connection with the intermediary device at least operational program related data from the remote site.

### BRIEF DESCRIPTION OF THE DRAWINGS

The foregoing and other aspects of the presently preferred embodiments of this invention are made more evident in the following Detailed Description of the invention, when read in conjunction with the attached Drawing Figures, wherein:

FIG. 1A is an elevational view of an embodiment of a personal mobility vehicle that is suitable for implementing the exemplary embodiments of this invention.

FIG. 1B shows in greater detail a user interface/control portion of the vehicle of FIG. 1A.

FIG. 2 is a simplified block diagram of a wheelchair system controller in accordance with the exemplary embodiments of this invention.

FIG. 3 is an elevational view of one exemplary embodiment of at least a portion of the user interface.

FIG. 4 is a logic flow diagram that illustrates the operation of a method, and a result of execution of computer program instructions embodied on a computer readable medium, in accordance with the exemplary embodiments of this invention.

### DETAILED DESCRIPTION

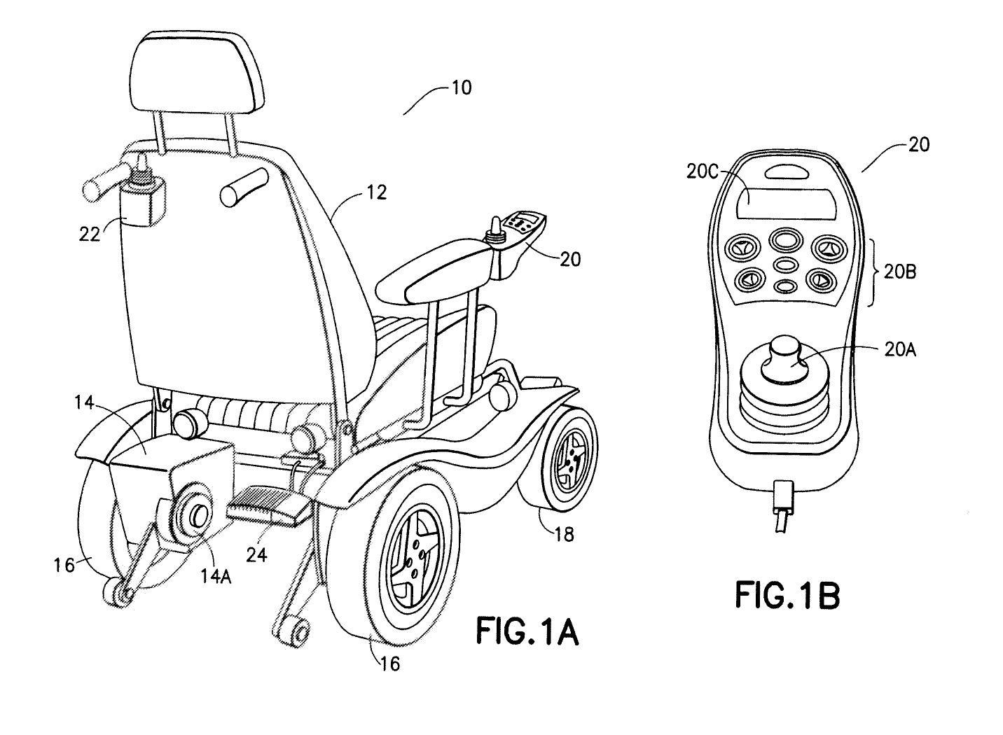

Before describing the exemplary embodiments of this invention in detail reference is first made to FIG. 1A for showing a rear elevational view of an embodiment of a personal mobility vehicle that is suitable for implementing the exemplary embodiments of this invention, as well as to FIG. 1B that shows in greater detail a user interface portion of the vehicle of FIG. 1A. In the embodiment shown in FIGS. 1A and 1B the personal mobility vehicle is embodied as a wheelchair system 10, although this is not a limitation upon the use and practice of the exemplary embodiments of this invention. As employed herein a wheelchair system is considered as a vehicle that may be capable of controlled, self-powered (e.g., battery powered) movement for a sitting person.

The wheelchair system 10 includes a seat portion 12, a power source 14, such as a battery and related power conversion, conditioning and recharging circuitry, and at least two wheels 16 that are driven by the power source 14 via at least one motor 14A. One or more other wheels 18 provide stability and enable steering of the wheelchair system 10. In this regard there is a user-actuated hand control system 20 that may include a joystick type controller 20A, a plurality of buttons 20B, and a display 20C, such as an LCD, LED or other suitable type of display system. An attendant control system 22 may also be provided. The control system 20 operates with a control system of controller 24 to provide functions that include, but need not be limited to, starting and stopping motive power to the drive wheels 16, controlling the direction of rotation and speed of rotation of the drive wheels 16, and controlling a pointing direction of the wheels 18 to provide steering of the wheelchair 10.

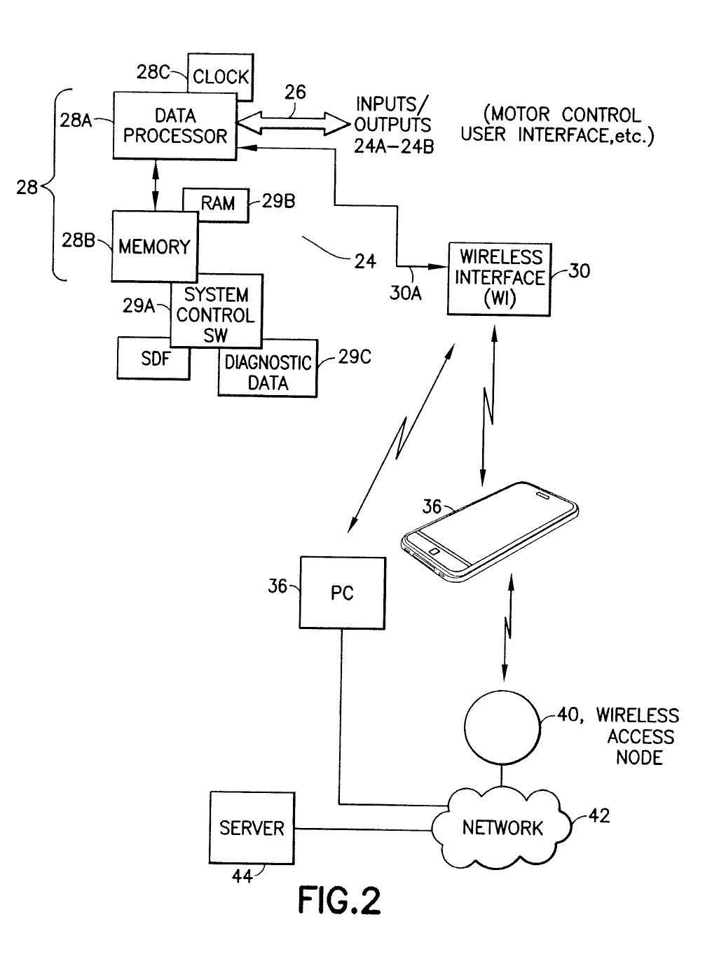

FIG. 2 shows a simplified block diagram of a portion of the controller 24. The controller 24 can be assumed to include a software system 28 that includes at least one data processor 28A, such as a microprocessor or microcontroller, and a non-transitory computer-readable medium such as a memory 28B that stores programs to control operation of the data processor 28A and, thereby, to control the overall operation of the wheelchair 10. The operating programs, also referred to as system control software (SW) 29A, may include firmware, such as computer programs that are permanently stored in, by example, non-volatile read only memory (NV-ROM), or system control SW 29A may be stored in volatile random access memory (RAM) 29B that is loaded from a disk or some other type of memory storage medium. The exemplary embodiments of this invention are also usable with a system where a system control SW 29A is stored in a mass memory device, such as a disk, and loaded into RAM as needed.

The system control SW 29A is assumed to include a system diagnostic function or functions (SDF), and to store in the memory diagnostic-related data (e.g., operational logs, failure logs, logs recording operational parameters of the power and drive system, etc.) as diagnostic data 29C.

In some embodiments a separate dedicated processor may be used to implement the diagnostics function, or the diagnostics function may be executed by the data processor 28A.

The data processor 28A is coupled via general use input/output hardware 26 to various input/outputs, including general input/outputs, such as input/outputs 24A going to and from the user-actuated hand control system 20 and inputs/outputs 24B providing control to the motor(s) 14. A clock function or module 28C can be included for maintaining an accurate time of day and calendar function.

Of most interest to the description of this invention is the interactivity of the data processor 28A with the system control SW 29A to be able to wirelessly upload the diagnostic data 29C to a remote location, as well as to receive from the same or a different remote location new and/or modified system control SW.

For this purpose FIG. 2 also shows a wireless interface (WI) 30, such as a Bluetooth™ interface, whereby a local, short range (e.g., meters or tens of meters) wireless connection can be made with a local intermediary device 36 such as a smartphone, a tablet computer, a laptop computer or a desktop PC, as several non-limiting examples. The intermediary device 36 can have wireless connectivity via an access node or portal 40 (e.g., a cellular radio system base station) to a network 42, such as the Internet, and thence to the remote location, which can be embodied as one or more servers 44. In some embodiments the intermediary device can be a PC or similar type of device and the connection to the network 42 can be via a wired connection (e.g., cable, optical cable, etc.)

The use of a Bluetooth™ interface is but one exemplary embodiment of a wireless interface 30, as other types of low power (or higher power) radio frequency and/or optical interfaces could be used including WiFi and other types of interfaces.

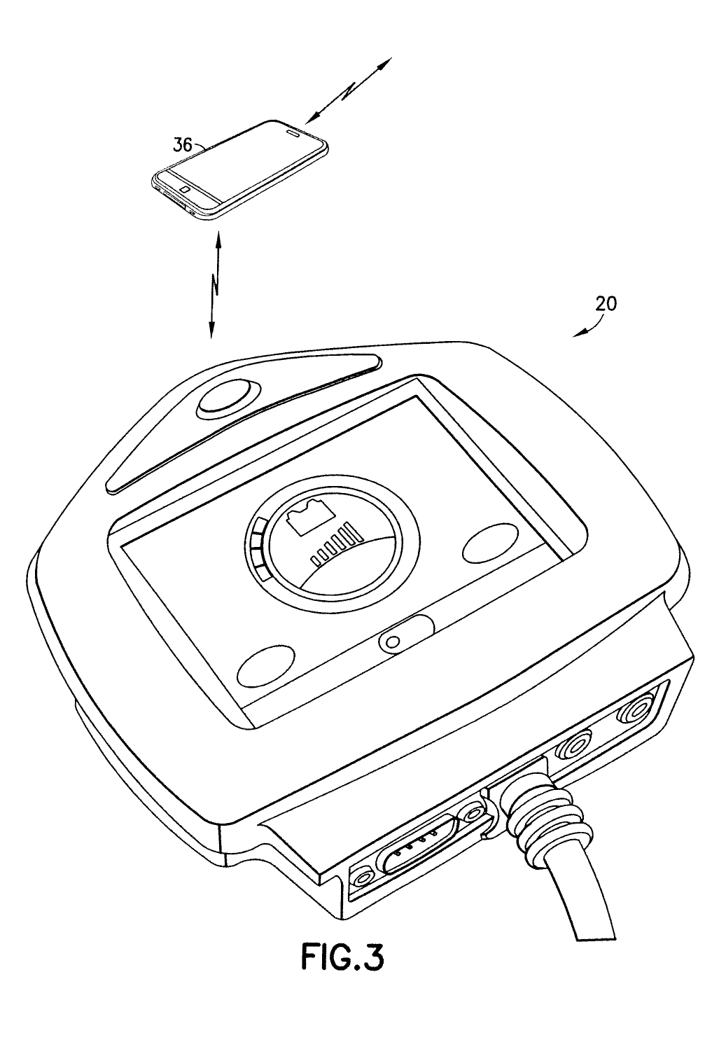

In one exemplary embodiment the wireless interface 30 (e.g., the Bluetooth™ interface) is provided as a module that is located within the hand control system 20 shown in FIG. 1B or, in another embodiment, in the hand control system/interface shown in FIG. 3.

In some embodiments it is possible to download and install new/updated system control program code or software 29A via the wireless interface 30. as well as to download/install tables and the like containing operational parameters, profiles and setpoints used during operation of the various wheelchair subsystems, including the motor drive subsystems, as well as adjustments to such performance-related data.

The use of the exemplary embodiments of this invention enables a wheelchair technician to remote access the wheelchair control system at least for the purpose of diagnostic review and retrieval, as well for performance tuning and making performance enhancements.

The WI 30 allows the wheelchair program and/or the monitor values to be automatically uploaded to a computer or smart phone (the intermediary device 36) and transmitted via the internet or cellular data network to a technician having access to the server 44. The technician can then evaluate the wheelchair system status remotely and determine if and in what module an incident is occurring. A new file can then be returned to be downloaded into the wheelchair system.

An additional embodiment utilizes the Bluetooth™ technology coupled with a secondary input device to provide drive and menu navigation commands to the wheelchair wirelessly. This will eliminate the need for additional cabling that could be cumbersome in situations where multiple transfers in and out of the wheelchair are required due to a medical condition if the wheelchair user.

The wireless PC/smart phone access enables the wheelchair user to customize their wheelchair graphical user interface, enable features such as infrared control for external devices and allows downloading of new firmware and firmware upgrades to the wheelchair system as well as performance adjustment and other types of parameters.

It may be preferred that only the wheelchair manufacturer or dealer/OEM have access to and the ability to download programming files and/or firmware and or operational parameters to the wheelchair 10. It may also be preferred that such access be protected using any suitable type of protection scheme or schemes such as passwords and/or encryption.

With regard to the uploading of the diagnostic data 29C, the upload may be initiated by the user of the wheelchair interacting with a menu function displayed on the display 20C or the upload may be remotely initiated by the technician associated with the server 44. In some embodiments the upload of the diagnostic data 29C may occur periodically based on a predetermined schedule (which can itself be modified locally or remotely). In this case data processor 28A can control the upload in cooperation with the clock function 28C to initiate the upload at a programmed (scheduled) time and date.

In general a command can be received from a user of the wheelchair system 10, or from an attendant or other person associated in some manner with the user. The command can be entered via at least one of the user interface that comprises, as non-limiting examples, a manual interface such as a touch screen interface; a user interface that comprises reception and interpretation of user-generated biometric signals; or a user interface that comprises a user voice transducer in combination with a voice recognition function. The user interface to generate the command to wirelessly transmit the vehicle diagnostic-related data from the wheelchair system 10 can take any number of forms, including one or more simple manually activated switches or a simple keypad. The biometric signals could be generated via any suitable type of interface such as a manually-operated interface or an eye or a gaze tracking interface or an interface that responds to electrical signals generated by or from the user, such as signals obtained from nervous system activity, as non-limiting examples.

A file or files representing the diagnostic data 29C is uploaded via the wireless interface 30 to the intermediary device 36, for example to an upload application program (app) running on the smartphone or tablet or PC, and then from the intermediary device 36 to the network 42 and server 44. No streaming of the diagnostic data in real-time is required. The diagnostic data can be buffered at the intermediary device 36 and reformatted by the application program resident there; it can also be compressed and/or encrypted if desired. Likewise, downloaded program or other operational data can be received in any suitable format at the intermediary device 36, and may be received in a protected (e.g., encrypted) format, and then decompressed, decrypted and reformatted if needed into a file format usable by the data processor 28A of the wheelchair system 10.

The path from the intermediary device 36 to the access node or portal 40/network 42 can use any suitable wired or wireless medium and protocols including, but not limited to, cellular telephone signals, WiFi signals, cable modem signals and the like.

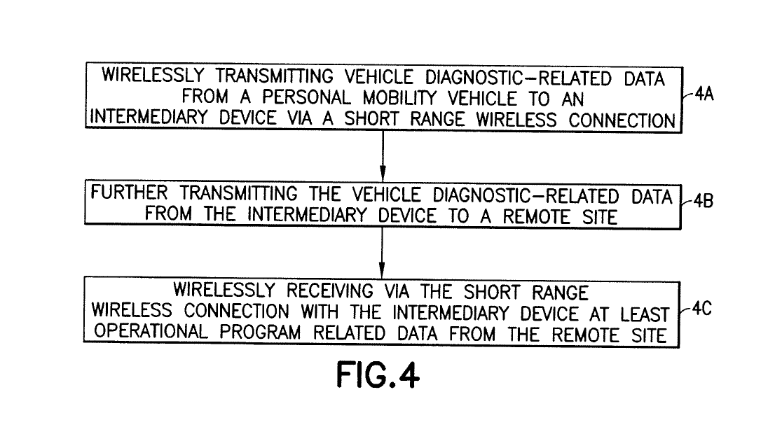

FIG. 4 is a logic flow diagram that illustrates the operation of a method, and a result of execution of computer program instructions embodied on a computer readable medium, in accordance with the exemplary embodiments of this invention. FIG. 4 shows a method to operate a personal mobility vehicle. At Block 4A there is a step of wirelessly transmitting vehicle diagnostic-related data from a personal mobility vehicle to an intermediary device via a short range wireless connection. At Block 4B there is a step of further transmitting the vehicle diagnostic-related data from the intermediary device to a remote site. At Block 4C there is a step of wirelessly receiving via the short range wireless connection with the intermediary device at least operational program related data from the remote site.

In the method as depicted in FIG. 4, where the steps of wirelessly transmitting and wirelessly receiving occur using a Bluetooth connection.

In the method as depicted in FIG. 4, where the intermediary device is comprised of a smartphone, a tablet computer, a laptop computer or a personal computer.

In the method as depicted in FIG. 4, where the step of wirelessly transmitting occurs in response to a command from a user of the personal mobility vehicle, where the command is entered via at least one of a user interface that comprises a manual interface such as a touch screen interface; a user interface that comprises reception and interpretation of user-generated biometric signals; or a user interface that comprises a user voice transducer in combination with a voice recognition function.

In the method as depicted in FIG. 4, where the step of wirelessly transmitting occurs in response to a command received from the remote site.

In the method as depicted in FIG. 4, where the step of wirelessly transmitting occurs periodically in accordance with a predetermined schedule.

In the method as depicted in FIG. 4, where the personal mobility vehicle is a wheelchair system.

In the method as depicted in FIG. 4, and further comprising a step of wirelessly receiving vehicle-related data at the vehicle from the intermediary device via the short range wireless connection, where the vehicle-related data can be comprised of at least one of new vehicle-related program code, an upgrade to existing vehicle-related program code, and vehicle performance adjustment data.

The invention also encompasses a non-transitory computer-readable medium that contains software program instructions, where execution of the software program instructions by at least one data processor results in performance of operations that comprise execution of the method depicted in FIG. 4 and described in the foregoing several paragraphs that are descriptive of FIG. 4.

As can be appreciated, an exemplary aspect of the embodiments of this invention is a diagnostic data upload and program file download system that is integrated into a personal mobility vehicle, such as the wheelchair system 10.

In these various embodiments it can be appreciated that the intermediary device 36 functions in a manner analogous to a relay device or module or system to relay data to and from the wheelchair system 10 via the short-range wireless connection provided by the wireless interface 30.

Note that various modifications and adaptations of the foregoing exemplary embodiments of this invention may become apparent to those skilled in the relevant arts in view of the foregoing description, when read in conjunction with the accompanying drawings and the appended claims. As but some examples, the use of the exemplary embodiments of this invention is not limited to wheelchairs, but could encompass other types of mobility systems.

Further, the user interface of the wheelchair system 10 may be implemented at least in part using voice recognition technology to enter user information and commands, and an acoustic transducer may present synthesized speech to the user, as opposed to the use of a visual display. That is, the technical specifics of the user input/output may vary widely depending on the physical capabilities of the user, and any suitable type of user input/output biometric means may be employed to implement the exemplary embodiments of this invention. In general, wirelessly transmitting information from the personal mobility vehicle system 10 can occur in response to a command from a user of the personal mobility vehicle, where the command is entered via at least one of a user interface that comprises a manual interface such as a touch screen interface; a user interface that comprises reception and interpretation of user-generated biometric signals; or a user interface that comprises a user voice transducer in combination with a voice recognition function.

However, all such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. A method to operate a personal mobility vehicle, comprising:
wirelessly transmitting vehicle diagnostic-related data from the vehicle to an intermediary device via a short range wireless connection;
further transmitting the vehicle diagnostic-related data from the intermediary device to a remote site; and
wirelessly receiving via the short range wireless connection with the intermediary device at least operational program related data from the remote site.

2. The method of claim 1, where wirelessly transmitting and wirelessly receiving occurs using a Bluetooth connection.

3. The method of claim 1, where the intermediary device is comprised of a smartphone, a tablet computer, a laptop computer or a personal computer.

4. The method of claim 1, where wirelessly transmitting occurs in response to a command from a user of the personal mobility vehicle, where the command is entered via at least one of a user interface that comprises a manual interface such as a touch screen interface; a user interface that comprises reception and interpretation of user-generated biometric signals; or a user interface that comprises a user voice transducer in combination with a voice recognition function.

5. The method of claim 1, where wirelessly transmitting occurs in response to a command received from the remote site.

6. The method of claim 1, where wirelessly transmitting occurs periodically in accordance with a predetermined schedule.

7. The method of claim 1, where the personal mobility vehicle is a wheelchair system.

8. The method of claim 1, further comprising wirelessly receiving vehicle-related data at the vehicle from the intermediary device via the short range wireless connection.

9. The method of claim 8, where the vehicle-related data is comprised of at least one of new vehicle-related program code, an upgrade to existing vehicle-related program code, and vehicle performance adjustment data.

10. A personal mobility vehicle, comprising:
a short range wireless interface; and
a control unit that comprises a data processor and a memory, said data processor being coupled to the wireless interface and configured to wirelessly transmit vehicle diagnostic-related data from the memory to an intermediary device via the short range wireless interface for subsequent transmission from the intermediary device to a remote site; said data processor further configured to wirelessly receive via the short range wireless interface with the intermediary device at least operational program related data from the remote site.

11. The personal mobility vehicle of claim 10, where said short range wireless interface is comprised of a Bluetooth interface.

12. The personal mobility vehicle of claim 10, where the intermediary device is comprised of a smartphone, a tablet computer, a laptop computer or a personal computer.

13. The personal mobility vehicle of claim 10, where said data processor wirelessly transmits the vehicle diagnostic-related data in response to a command from a user of the personal mobility vehicle, where the command is entered via at least one of a user interface that comprises a manual interface such as a touch screen interface; a user interface that comprises reception and interpretation of user-generated biometric signals; or a user interface that comprises a user voice transducer in combination with a voice recognition function.

14. The personal mobility vehicle of claim 10, where said data processor wirelessly transmits the vehicle diagnostic-related data in response to a command that is wirelessly received from the remote site.

15. The personal mobility vehicle of claim 10, where said data processor wirelessly transmits the vehicle diagnostic-related data periodically in accordance with a predetermined schedule.

16. The personal mobility vehicle of claim 10, where the personal mobility vehicle is a wheelchair system.

17. The personal mobility vehicle of claim 16, where said wireless interface is embodied in a user-actuated mobility control system of the wheelchair system.

18. The personal mobility vehicle of claim 10, where said wireless interface and control unit are further configured to wirelessly receive vehicle-related data at the vehicle from the intermediary device via the short range wireless connection.

19. The personal mobility vehicle of claim 18, where the vehicle-related data is comprised of at least one of new vehicle-related program code, an upgrade to existing vehicle-related program code, and vehicle performance adjustment data.

20. A non-transitory computer-readable medium that tangibly stores a computer program for execution by a data processor to operate a wheelchair system by performing operations that comprise:
wirelessly transmitting vehicle diagnostic-related data from the wheelchair system to an intermediary device via a short range wireless connection so that the vehicle diagnostic-related data can be relayed to a remote site; and
wirelessly receiving via the short range wireless connection with the intermediary device at least operational program related data from the remote site.

21. The computer-readable medium as in claim 20, where wirelessly transmitting and wirelessly receiving occurs using a Bluetooth connection.

22. The computer-readable medium as in claim 20, where the intermediary device is comprised of a smartphone, a tablet computer, a laptop computer or a personal computer.

23. The computer-readable medium as in claim 20, where at least wirelessly transmitting occurs in response to a command from a user of the personal mobility vehicle, or in response to a command received from the remote site, or periodically in accordance with a predetermined schedule.

24. The computer-readable medium as in claim 20, where at least wirelessly transmitting occurs in response to a command from a user of the personal mobility vehicle, where the command is entered via at least one of a user interface that comprises a manual interface such as a touch screen interface; a user interface that comprises reception and interpretation of user-generated biometric signals; or a user interface that comprises a user voice transducer in combination with a voice recognition function.

25. The computer-readable medium of claim 20, where the operational program related data is comprised of at least one of new vehicle-related program code, an upgrade to existing vehicle-related program code, and vehicle performance adjustment data.
